(19) United States
(12) Patent Application Publication
(10) Pub. No.: US 2019/0205976 A1
(43) Pub. Date: Jul. 4, 2019

(54) ACCOUNT NUMBER REGISTRATION METHOD, APPARATUS, AND SYSTEM

(71) Applicant: TENCENT TECHNOLOGY (SHENZHEN) COMPANY LIMITED, Shenzhen (CN)

(72) Inventors: Peng JIANG, Shenzhen (CN); Jin Hua WANG, Shenzhen (CN); Ping Jin XIE, Shenzhen (CN); Chang SHENG, Shenzhen (CN); Hui WANG, Shenzhen (CN); Xin Cheng XU, Shenzhen (CN); Yan Shan FENG, Shenzhen (CN); Zhi Kai MAI, Shenzhen (CN)

(73) Assignee: TENCENT TECHNOLOGY (SHENZHEN) COMPANY LIMITED, Shenzhen (CN)

(21) Appl. No.: 16/296,607

(22) Filed: Mar. 8, 2019

Related U.S. Application Data
(63) Continuation of application No. PCT/CN2017/108888, filed on Nov. 1, 2017.

(30) Foreign Application Priority Data
Jan. 11, 2016 (CN) 201610934952.X

(51) Int. Cl. G06Q 40/02; G06Q 20/40

(52) U.S. Cl. CPC G06Q 40/02; G06Q 20/4014; G06Q 20/407

(57) ABSTRACT

An account number registration method is provided. Indication information transmitted by a transaction server is received, the indication information including a second business account number of a terminal, a second account name corresponding to the second business account number, and a second recipient account number, a resource being transferred out from the second business account number to the second recipient account number. A registered account number is allocated according to a first account name in response to the second business account number being the same as a first business account number that is pre-stored, the second account name being the same as the first account name that is pre-stored, and the second recipient account number being the same as a first recipient account number that is pre-stored. A notification message indicating a registration success is transmitted to the terminal.

### CROSS-REFERENCE TO RELATED APPLICATIONS

This application is a continuation of International Application No. PCT/CN2017/108888, filed on Nov. 1, 2017, in the Chinese Patent Office, which claims priority to Chinese Patent Application No. 201610934952X, entitled “ACCOUNT NUMBER REGISTRATION METHOD, APPARATUS, AND SYSTEM” filed with the Patent Office of China on Nov. 1, 2016, the disclosures of which are incorporated by reference in their entireties.

### BACKGROUND

### 1. Field

Methods, apparatuses, and systems consistent with exemplary embodiments relate to the field of computer technologies, and in particular, to account number registration.

### 2. Description of the Related Art

An information exchange platform refers to a network architecture that connects one person to another person by using social relationships and/or common interests (or common benefits). A user may perform daily communication and process some daily transactions by using a client provided by the information exchange platform.

Each user, such as an enterprise, a business, or an institution, needs to register, on an information exchange platform, an account number for being identified by another user on the information exchange platform. The account number may be a subscription account number, an enterprise account number, a service account number, or an application account number.

In the related technology, when registering an account number on an information exchange platform, a user sends registration information to a server of the information exchange platform by using a terminal. The registration information at least includes a photograph of a business license of an enterprise, a business, or an institution and an account name of the user. After obtaining the registration information by using the server, working personnel of the information exchange platform make searches on websites of departments concerning granting of a business license to check whether the business license in the photograph is legal (or authentic), and when determining that the business license is legal, determine that authentication on an identity of the user succeeds, and allocate an account number for the user according to the account name.

The working personnel need to check legality of the business license on the websites of the departments concerned one by one. Because a process of manual authentication consumes a great amount of time, efficiency in registration of an account number is relatively low. Also, accuracy of an authentication procedure may be lowered due to possible human error.

### SUMMARY

One or more exemplary embodiments provide an account number registration method and a related device and system that can improve efficiency in registration of an account number and accuracy of an authentication procedure.

According to an aspect of an exemplary embodiment, an account number registration method is provided. Indication information transmitted by a transaction server is received, the indication information including a second business account number of a terminal, a second account name corresponding to the second business account number, and a second recipient account number, a resource being transferred out from the second business account number to the second recipient account number. A registered account number is allocated according to a first account name in response to the second business account number being the same as a first business account number that is pre-stored, the second account name being the same as the first account name that is pre-stored, and the second recipient account number being the same as a first recipient account number that is pre-stored. A notification message indicating a registration success is transmitted to the terminal.

According to an aspect of another exemplary embodiment, an account number registration method is provided, including:

sending a business account to a registration server, the business account including a first account name and a first business account number;

receiving a recipient account including the first recipient account number sent by the registration server, the first recipient account number being used for receiving, through the transaction server, the resource transferred by the first business account number; and

receiving a notification message used for indicating a registration success sent by the registration server.

According to an aspect of still another exemplary embodiment, a registration server is provided, including:

a receiver, configured to receive indication information transmitted by a transaction server, the indication information including a second business account number of a terminal, a second account name corresponding to the second business account number, and a second recipient account number, a resource being transferred out from the second business account number to the second recipient account number;

a processor, configured to allocate a registered account number according to a first account name in response to the second business account number being the same as a first business account number that is pre-stored, the second account name being the same as the first account name that is pre-stored, and the second recipient account number being the same as a first recipient account number that is pre-stored; and

the transmitter being further configured to send a notification message used for indicating a registration success to the terminal.

According to an aspect of still another exemplary embodiment, a terminal is provided, including:

a transmitter, configured to send a business account to a registration server, the business account including a first account name and a first business account number; and

a receiver, configured to receive a recipient account including the first recipient account number sent by the registration server, the first recipient account number being used for receiving, through the transaction server, the resource transferred by the first business account number; and

the receiver being further configured to receive a notification message used for indicating a registration success sent by the registration server.

According to an aspect of still another exemplary embodiment, a non-transitory computer program product is provided, which, when the computer product is executed, performs the method according to one or more aspects of this application.

According to an aspect of still another exemplary embodiment, a computer readable storage medium including an instruction, the instruction, when being executed on a registration server, causing the registration server to perform the method according to the first aspect.

According to an aspect of still another exemplary embodiment, a computer readable storage medium including an instruction, the instruction, when being executed on a terminal, causing the terminal to perform the method according to the second aspect.

According to an aspect of still another exemplary embodiment, an account number registration system is provided, including a registration server, a transaction server, and a terminal, the registration server being the registration server according to the third aspect, and the terminal being the terminal according to the fourth aspect.

The technical solutions provided in the disclosure have the following beneficial effects:

In an account number registration process, the registration server receives indication information sent by the transaction server. Because the indication information includes a second business account number that transfers out a resource, a second account name corresponding to the second business account number, and a second recipient account number that receives that resource, when the second business account number is the same as a pre-stored first business account number, the second account name is the same as a pre-stored first account name, and the second recipient account number is the same as a pre-stored first recipient account number, it is determined that authentication succeeds. After the authentication succeeds, a registered account number is automatically allocated without manually performing authentication on legality of a business license, so that efficiency of account number registration can be improved.

### BRIEF DESCRIPTION OF THE DRAWINGS

The above and/or other aspects will become apparent and more readily appreciated by describing certain exemplary embodiments with reference to the accompanying drawings, in which:

FIG. 1 is a schematic structural diagram of an account number registration system according to some exemplary embodiments;

FIG. 2 is a method flowchart of an account number registration method according to an embodiment;

FIG. 3 is a method flowchart of an account number registration method according to another embodiment;

FIG. 4 is a schematic diagram of a registration information filling interface according to another embodiment;

FIG. 5 is a schematic diagram of a transaction interface according to another embodiment;

FIG. 6 is a method flowchart of an account number registration method according to another embodiment;

FIG. 7 is a structural block diagram of a registration server according to an embodiment;

FIG. 8 is a structural block diagram of a terminal according to still another embodiment;

FIG. 9 is a structural block diagram of a registration server according to an embodiment; and

FIG. 10 is a structural block diagram of a terminal according to an embodiment.

### DETAILED DESCRIPTIONS

To make the objectives, technical solutions, and advantages of the disclosure clearer, the following further describes implementations of the disclosure in detail with reference to the accompanying drawings.

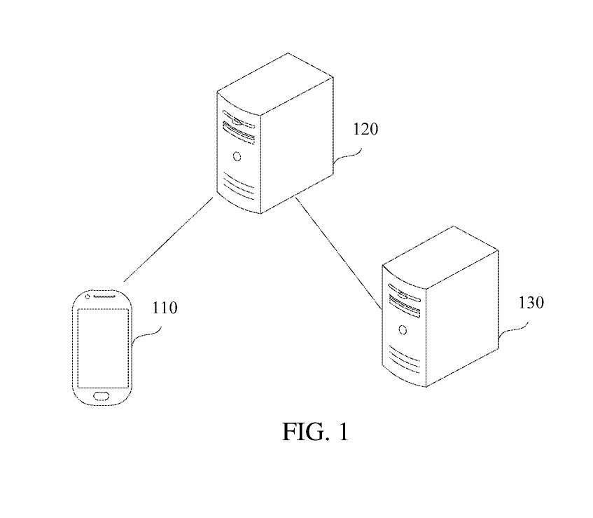

FIG. 1 is a schematic structural diagram of an account number registration system according to an exemplary embodiment. The account number registration system includes a terminal 110, a registration server 120, and a transaction server 130. A terminal 110 establishes a connection to the registration server 120 through a wired network or a wireless network, and the registration server 120 establishes a connection to the transaction server 130.

The terminal 110 is a device having data receiving and transmitting functions, for example, a smart phone. An application client provided by an information exchange platform is installed in the terminal 110, or a browser is installed in the terminal 110, and a web page client of an information exchange platform is accessed by using the browser. For example, when the information exchange platform is a WeChat public platform, the terminal may be a WeChat client, or may be a browser capable of logging in to a web page of a WeChat public platform.

The account number registered on the information exchange platform may be, for example but not limited to, a subscription account number, an enterprise account number, a service account number, and/or an application account number. The subscription account number is an account number registered by media or an individual and used for information dissemination. The enterprise account number is an account number that provides a mobile application portal for an enterprise, to help the enterprise establish connections to employees, upstream and downstream supply chains, and an enterprise application. The service account number is an account number that provides a business service and a user management capability for an enterprise. The application account number is an account number providing an application function.

The registration server 120 is a backend server of an information exchange platform and may be a server cluster including one or more servers or a cloud computing center.

The registration server 130 is a bank server and may be a server cluster including one or more servers or a cloud computing center.

In an exemplary embodiment, the registration server 120 instructs, by using a terminal, a user to transfer a resource to the transaction server 130, the transaction server 130 notifies the registration server 120 of a resource transfer situation, and the registration server 120 further performs authentication on an identity of the user according to the resource transfer situation. After the authentication succeeds, the registration server 120 allocates a registered account number for the user, and instructs the transaction server 130 to return the resource transferred by the user to the user.

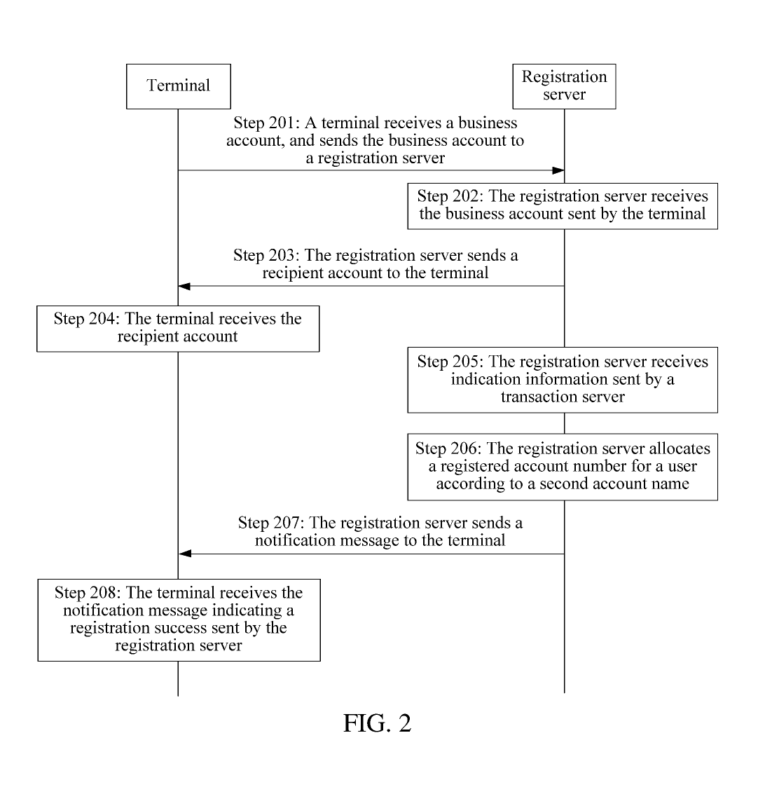

FIG. 2 is a method flowchart of an account number registration method according to an embodiment, and the account number registration method can be applied to the account number registration system shown in FIG. 1. The account number registration method includes the following operations.

Operation 201: A terminal receives a business account including a first account name and a first business account number input by a user, and sends the business account to a registration server.

The account name refers to a name filled in by a person in charge of an enterprise, a business, or an institution when the person in charge opens an account in a bank with legal certificates such as a business license. Therefore, the account name recorded by the bank is authentic and effective. For example, an account name filled in by a person in charge of “xx Cooperation Limited” when the person in charge opens an account in a bank is “xx Cooperation Limited”. In this embodiment, an account name input by a user is referred to as a first account name.

The business account number refers to an account number of a bank account handled by a person in charge of an enterprise, a business, or an institution with legal certificates such as a business license in a bank. Therefore, the business account number recorded by the bank is authentic and effective. For example, if a bank account number handled by a person in charge of “xx Cooperation Limited” in a bank is 62xxxxxxxxxxxxx, a business account number of “xx Cooperation Limited” is 62xxxxxxxxxxxxx. In this embodiment, a business account number input by a user is referred to as a first business account number.

When registering an account number on an information exchange platform, a terminal sends registration request to a registration server, the registration server feeds back a registration information filling interface to the terminal, and a user fills in registration information in the registration information filling interface. The registration information filling interface at least includes an account name input box and a business account number input box, and the terminal uses input content in the account name input box as a first account name, and uses input content in the business account number input box as a first business account number.

Operation 202: The registration server receives the business account sent by the terminal.

Operation 203: The registration server generates a recipient account including a first recipient account number and sends the recipient account to the terminal.

The first recipient account number is used for receiving, through the transaction server, the resource transferred by the first business account number.

The recipient account number is a bank account number of an enterprise, a business, or an institution providing the information exchange platform. In this embodiment, the recipient account number generated by the registration server is referred to as a first recipient account number.

Operation 204: The terminal receives the recipient account including the first recipient account number generated and sent by the registration server.

The terminal displays the received recipient account number. A user may transfer a resource from the first business account number to the first recipient account number by using the terminal. Alternatively, a user may transfer a resource from the first business account number to the first recipient account number in another manner instead of using the terminal. For example, when the resource is money, a user may use an online bank by using the terminal to handle a service of remittance from the first business account number to the first recipient account number. Alternatively, a user may go to a specific bank to handle a service of remittance from the first business account number to the first recipient account number without using the terminal.

When transferring a resource from the first business account number to the first recipient account number transfer resource, the user sends a resource transfer request to the transaction server, the resource transfer request carrying the first business account number that transfers out the resource, the first account name corresponding to the first business account number, the first recipient account number that receives the resource, and a transfer value of the resource. After receiving the resource transfer request, the transaction server extracts the resource indicated by the transfer value from the first business account number, transfers the resource to the first recipient account number, generates indication information including the first business account number, the first account name, the first recipient account number, and the transfer value, and sends the indication information to the registration server. That is, the registration server performs operation 205, as described below.

Because the transfer value is not necessary when identity authentication is performed on the user, the indication information does not need to include the transfer value.

Operation 205: The registration server receives indication information sent by a transaction server.

The indication information includes a second business account number that transfers out a resource, a second account name corresponding to the second business account number, and a second recipient account number that receives the resource.

Because a plurality of terminals may simultaneously apply for registered account numbers, a user of every terminal needs to transfer a resource by using the transaction server, and it is likely that the indication information sent by the transaction server this time is not the indication information generated when the user transfers the resource in operation 201. In an exemplary embodiment, to distinguish from the foregoing first business account number, first account name, and first recipient account number, the business account number in the indication information may be referred to as the second business account number, the account name in the indication information may be referred to as the second account name, and the recipient account number in the indication information may be referred to as the second recipient account number.

Operation 206: The registration server allocates a registered account number for the user according to a second account name when a second business account number is the same as the first business account number, the second account name is the same as the first account name, and a second recipient account number is the same as the first recipient account number.

The registration server compares the second business account number, the second account name, and the second recipient account number in the indication information respectively with each set of a first business account number, a first account name, and a second recipient account number pre-stored in the registration server. A comparison sequence of the three types of information is not limited in this embodiment.

If a comparison result is that the second business account number is the same as the first business account number, the second account name is the same as the first account name, and the second recipient account number is the same as the first recipient account number, because the second business account number and the second account name are both recorded in the transaction server, and are authentic and effective, the registration server can determine that the first business account number and the first account name that are sent by the terminal are authentic and effective. Thus, the identity authentication on the user is successful, and a registered account number is allocated for the user according to the first account name.

If a comparison result is that at least one pair among pairs of the second business account number and the first business account number, the second account name and the first account name, and the second recipient account number and the first recipient account number is different, it is indicated that fake information exists in the first business account number and the first account name sent by the terminal. Accordingly, identity authentication on the user fails, and no registered account number is allocated to the user.

Operation 207: The registration server sends a notification message used for indicating a registration success to the terminal.

The notification message may further include the registered account number allocated by the registration server for the user.

Operation 208: The terminal receives the notification message used for indicating a registration success sent by the registration server.

Operations 201, 204, and 208 can be independently implemented as an embodiment on the terminal side, and operations 202, 203, and 205-207 can be independently implemented as an embodiment on the registration server side.

In conclusion, the account number registration method provided by an exemplary embodiment includes: in an account number registration process, first receiving, by the registration server, a business account including the first account name and the first business account number of the user sent by the terminal; further, generating a recipient account including the first recipient account number and sending the recipient account to the terminal; and receiving indication information sent by the transaction server. Because the indication information includes a second business account number from which the user transfers out a resource, a second account name corresponding to the second business account number, and a second recipient account number that receives that resource, when the second business account number is the same as the first business account number, the second account name is the same as the first account name, and the second recipient account number is the same as the first recipient account number, it is determined that authentication on identity of the user succeeds. After the authentication succeeds, a registered account number is automatically allocated for the user without manually performing authentication on legality of a business license, so that efficiency of account number registration can be improved.

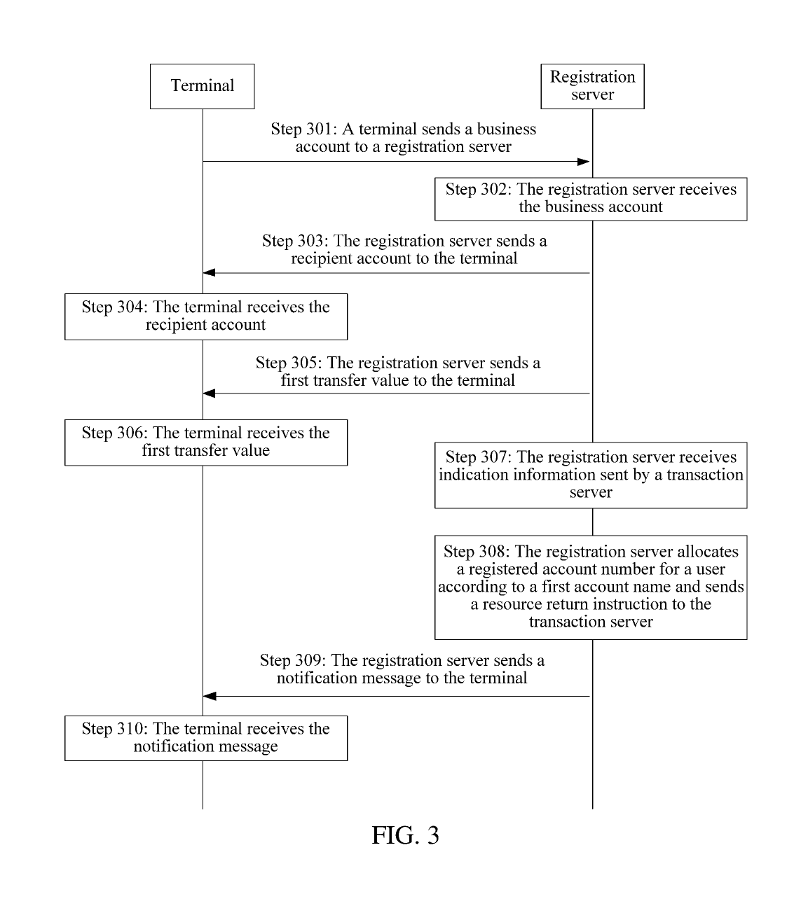

FIG. 3 is a method flowchart of an account number registration method according to another detailed embodiment, and the account number registration method can be applied to the account number registration system shown in FIG. 1. The account number registration method includes the following operations.

Operation 301: A terminal receives a business account including a first account name and a first business account number input by a user, and sends the business account to a registration server.

Descriptions in the embodiment shown in FIG. 2 may be referred to for detailed descriptions on the account name and the business account number. Repetitive details are not described herein again.

Descriptions in the embodiment shown in FIG. 2 may be referred to for detailed process of registering an account number on the information exchange platform. Repetitive details are not described herein again.

The business account may further include a bank name and a bank address.

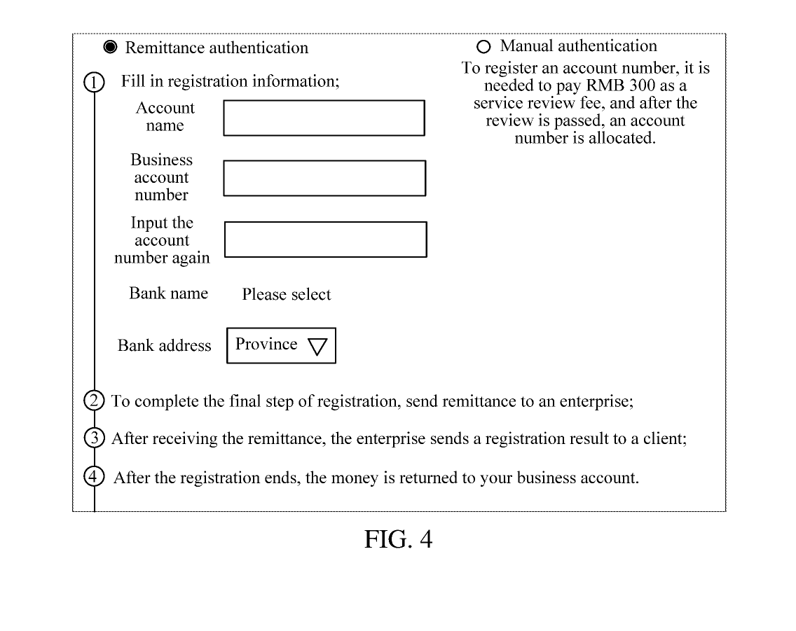

FIG. 4 illustrates a schematic diagram of a registration information filling interface. Referring to FIG. 4, the registration information filling interface includes two registration methods items of “Remittance authentication” and “Manual authentication”, and registration items are respectively displayed below the two registration methods items. For example, four registration items relating to a registration procedure are displayed below “Remittance authentication”, and a registration item relating to requirements for registration are displayed below “Manual authentication”.

When a user selects “Remittance authentication”, registration information input boxes and a registration procedure are disposed below “Remittance authentication”. The registration information input boxes include an account name input box, a business account number input box, a bank name selection box, and a bank address selection box, and the user inputs information respectively in the registration information input boxes.

Operation 302: The registration server receives the business account sent by the terminal.

Operation 303: The registration server generates a recipient account including a first recipient account number and sends the recipient account to the terminal.

The first recipient account number includes a transaction account number receiving the resource transferred by the first business account number and a check code, and a check code in each first recipient account number uniquely identifying the first recipient account number.

The recipient account number is a bank account number of an enterprise, a business, or an institution providing the information exchange platform. In this embodiment, the recipient account number generated by the registration server is referred to as a first recipient account number.

The first recipient account number is a bank account number of an enterprise, a business, or an institution providing the information exchange platform. For example, the first recipient account number is 61xxxxxxxxxxxxx. When the first recipient account number is the foregoing bank account number, it is likely that the bank account number is used for transferring a resource of another service in addition to transferring a resource of account number registration. In this case, the registration server cannot determine, according to the bank account number, whether a current service is account registration. Therefore, the registration server may further generate, based on the bank account number, the first recipient account number. In this case, the generated first recipient account number is merely used for transferring a resource of account number registration.

When the registration server generates the first recipient account number based on the bank account number, the first recipient account number needs to includes the bank account number because the resource needs to be transferred into the bank account number. The registration server may further set a check code in the first recipient account number. To be specific, the first recipient account number includes a transaction account number and a check code. The transaction account number is a bank account number of an enterprise, a business, or an institution providing the information exchange platform. In this embodiment, a same generation rule is used for each first recipient account number, and a location relationship between the transaction account number and the check code in the first recipient account number is not limited.

The registration server can obtain the transaction account number after receiving the first account name and the first business account number, randomly generate a check code, and arrange the transaction account number and the check code according to a generation rule, to obtain the first recipient account number. To facilitate understanding, a check code being located behind a transaction account number is used as an example for description. Assuming that a transaction account number is 61xxxxxxxxxxxxx, a check code is 0406001736 of 10 bits, the first recipient account number is 61xxxxxxxxxxxxx0406001736.

A check code in each first recipient account number uniquely identifies the first recipient account number. For example, if the recipient account is 61xxxxxxxxxxxxx, and n is 10, when a terminal 1 registers an account number, a possible recipient account number is 61xxxxxxxxxxxxx0406001736; and when a terminal 2 registers an account number, a possible recipient account number is 61xxxxxxxxxxxxx8549160300.

Because the check code in each first recipient account number uniquely identifies the first recipient account number, recipient account numbers received by different terminals are different, and accuracy of an authentication procedure can be improved by performing authentication on the recipient account number. Therefore, security of an account number can be improved.

After receiving the business account, the registration server further generates an account number identifier corresponding to the business account, and identifies terminal by using the account number identifier. To be specific, after generating the recipient account, the registration server determines the terminal that sends the business account according to the account number identifier, and sends the recipient account to the terminal.

Operation 304: The terminal receives the recipient account including the first recipient account number generated and sent by the registration server.

When the user transfers a resource from the first business account number to the first recipient account number, the user further needs to determine a first transfer value of the resource. The first transfer value is used for indicating a value of a resource transferred from the first business account number to the first recipient account number.

In a possible implementation, the first transfer value is determined by a user, or is a default value of a terminal. In this case, operation 307 is performed. In operation 307, the registration server receives indication information sent by the transaction server.

In another possible implementation, the first transfer value is specified by the registration server. In this case, operation 305 is performed.

Operation 305: The registration server randomly selects a first transfer value from a preset value range, and sends the first transfer value to the terminal.

The first transfer value is used for indicating a value of a resource transferred from the first business account number to the first recipient account number.

In this embodiment, the first transfer value specified by the registration service may be a fixed value, or the first transfer value may be a value randomly selected from a preset value range. Because an objective of instructing the user to transfer a resource from the first business account number to the first recipient account number transfer resource is to perform authentication on legality and accuracy of the first business account number, the registration server can achieve the objective by selecting a preset value range whose maximum value is less than a preset threshold, to reduce loss caused by a resource transfer failure.

For example, the preset value range may be (0.001 to 1). The registration server may further modify values of two ends of the preset value range and a range length. The registration server may alternatively select a preset value range whose maximum value is equal to a preset threshold. No limitation is imposed in this embodiment.

Because the first transfer value is randomly selected, it would be difficult for a malicious person to obtain a correct first transfer value, so that security of account number registration can be improved.

Operation 306: The terminal receives the first transfer value selected from the preset value range and sent by the registration server.

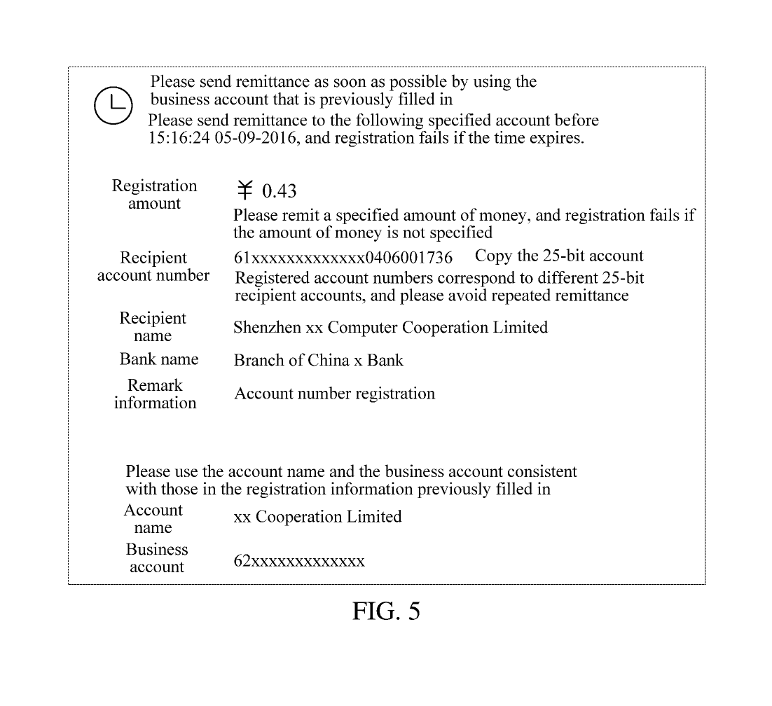

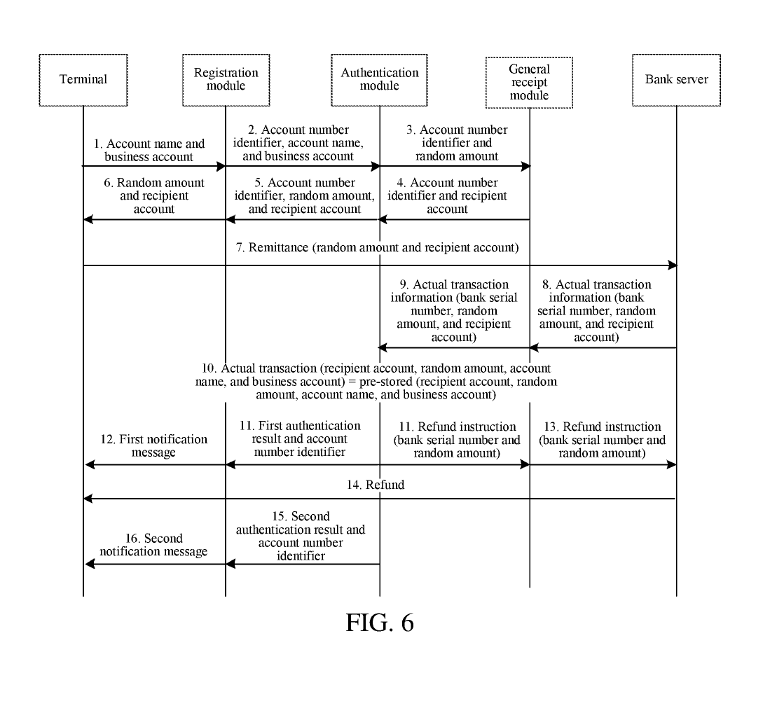

The terminal may further display the received recipient account and transfer value in the transaction interface. FIG. 5 is a schematic diagram of a transaction interface according to another embodiment. Referring to FIG. 5, a transfer value is 0.43, a recipient account number in a recipient account is 61xxxxxxxxxxxxx0406001736, a recipient name of an enterprise providing an information exchange platform is “Shenzhen xx Computer Cooperation Limited”, a bank name of the enterprise is “xx Branch of China x Bank”, remark information is “Account number registration”, an account name of a user is “xx Cooperation Limited”, and a business account number is “62xxxxxxxxxxxxx”.

Because the recipient account number includes a large quantity of bits, and when the user transfers a resource from the business account number to the recipient account number by using the terminal, it is likely to fill in an incorrect recipient account number, the transaction interface may further provide a control for copying the transfer resource, so that the user can transfer the resource to the copied recipient account number, to improve convenience and accuracy in resource transferring. In FIG. 5, a copying control “Copy the 25-bit account number” is displayed behind the recipient account number.

In FIG. 5, the terminal further displays, nearby the displayed information such as the transfer value, the recipient account number, the account name, and business account number, operation requirements for resource transferring generated according to the information, to prompt the user to accurately transfer the resource, thereby a success rate of resource transferring. For example, the operation requirements may include “Please send remittance to the following specified account before 15:16:24 05-09-2016, and registration fails if the time expires”, “Please remit a specified amount of money, and registration fails if the amount of money is not specified”, “Registered account numbers correspond to different 25-bit recipient account numbers, and please avoid repeated remittance”, and “Please use the account name and the business account number consistent with those in the registration information previously filled in”.

After the terminal displays the transaction interface, a user may transfer a resource from the first business account number to the first recipient account number by using the terminal, or a user may transfer a resource from the first business account number to the first recipient account number in another manner instead of using the terminal.

For example, when the resource is money, a user may use an online bank by using the terminal to handle a service of remittance from the first business account number to the first recipient account number. Alternatively, a user may go to a specific bank to handle a service of remittance from the first business account number to the first recipient account number without using the terminal.

When transferring a resource from the first business account number to the first recipient account number transfer resource, the user sends a resource transfer request to the transaction server, the resource transfer request carrying the first business account number that transfers out the resource, the first account name corresponding to the first business account number, the first recipient account number that receives the resource, and a transfer value of the resource. After receiving the resource transfer request, the transaction server extracts the resource indicated by the transfer value from the first business account number, transfers the resource to the first recipient account number, generates indication information including the first business account number, the first account name, the first recipient account number, and the transfer value, and sends the indication information to the registration server. That is, the registration server performs operation 307, in which the registration server receives indication information sent by the transaction server.

Because when identity authentication is performed on the user, the transfer value is not necessary, and the indication information does not need to include the transfer value.

When the first recipient account number is a bank account number, it is likely that the bank account number is used for transferring a resource of another service in addition to transferring a resource of account number registration. In this case, the transaction server cannot determine, according to the bank account number, whether a current service is account registration. If all pieces of indication information based on the bank account number are sent to the registration serve, an amount of data received by the registration server is excessive, resulting in low efficiency in subsequent identity authentication. Moreover, when the first recipient account number includes a transaction account number and a check code, the transaction server may determine, according to the first recipient account number, whether a current service is account registration, and send indication information including the first recipient account number to the registration server, to reduce an amount of data received by the registration server, thereby improving efficiency of identity authentication. To be specific, when determining that the second business account number includes a check code, the transaction server sends indication information including the second business account number.

Operation 307: The registration server receives indication information sent by a transaction server.

The indication information includes a second business account number from which a user transfers out a resource, a second account name corresponding to the second business account number, and a second recipient account number that receives the resource.

Because a plurality of terminals may simultaneously apply for registered account numbers, a user of a terminal needs to transfer a resource by using the transaction server, and it is likely that the indication information sent by the transaction server to transfer the resource is not the indication information generated when the user transfers the resource in operation 201. In an exemplary embodiment, to distinguish from the foregoing first business account number, first account name, and first recipient account number, the business account number in the indication information may be referred to as the second business account number, the account name in the indication information may be referred to as the second account name, and the recipient account number in the indication information may be referred to as the second recipient account number.

Normally, the transaction server can only identify a transaction account number of a fixed quantity of bits. For example, if a quantity of bits of a bank account number handled by a bank to which a transaction server belongs, the transaction server can only identify a 15-bit transaction account number, and when a quantity of bits of a recipient account number is not 15, the transaction server cannot identify the recipient account number.

In an exemplary embodiment, an enterprise, a business, or an institution providing an information exchange platform and a bank formulate a protocol in advance. The protocol regulates a 15-bit transaction account number. In this way, when receiving a service for transferring a resource to a recipient account number with more than 15 bits, the transaction server detects whether the first 15 bits in the recipient account number is a transaction account number regulated in the protocol, and when the first 15 bits in the recipient account number is a transaction account number regulated in the protocol, the transaction server no longer reads the remaining check code, directly determines that the recipient account number is a correct recipient account number, and transfers the resource to the 15-bit transaction account number, to complete a transaction.

When receiving the service for transferring the resource from the business account number to the recipient account number, the transaction server further generates a transaction serial number. The transaction serial number is used for identifying a current resource transfer service.

The registration server may further set a time limit for the terminal to transfer a resource to the transaction server. To be specific, when sending the recipient account to the terminal, the registration server starts timing, and when the timed time length reaches a preset time length, if indication information sent by transaction server is not received, sends a notification message indicating a registration failure to the terminal. Correspondingly, the terminal receives the notification message indicating the registration failure sent by the registration server.

Specifically, the registration server may determine, according to the account number identifier, the terminal that sends registration information, and sends the notification message to the terminal. The notification message may further include a reason, such as registration timeout, for the registration failure.

Before the timed time length reaches the preset time length, if indication information sent by the transaction server is received, operation 308 is performed.

Operation 308: Allocate a registered account number for the user according to the first account name when a second business account number is the same as the first business account number, a second account name is the same as the first account name, and a second recipient account number is the same as the first recipient account number, and send a resource return instruction to the transaction server.

The resource return instruction is used for instructing the transaction server to return, from the first recipient account number, the resource, that is transferred out from the first business account number to the first recipient account number, to the first business account number.

When the first recipient account number is a bank account number, all the second recipient account numbers are the same, the registration server needs to respectively compare the second business account number, the second account name, and the second recipient account number in the indication information with each set of a first business account number, a first account name, and a second recipient account number pre-stored in the registration server, more time needs to be consumed, and authentication efficiency is relatively low. For a detailed comparison process, refer to descriptions in operation 206. Details are not described herein again.

When the first recipient account number includes a transaction account number and a check code, after receiving indication information, the registration server first searches all the sent first recipient account numbers for a first recipient account number the same as the second recipient account number.

When the first recipient account number is found, the registration server further searches for a first business account number, a first account name, and a first transfer value that are received when the first recipient account number is generated, detects whether the second business account number is the same as the found first business account number, whether the second account name is the same as the found first account name, and whether the second transfer value is the same as the found first transfer value.

When the second business account number is the same as the found first business account number, the second account name is the same as the found first account name, and the second transfer value is the same as the found transfer value, because the second business account number and the second account name are both recorded in the transaction server, and are authentic and effective, the registration server can determine that the first business account number and the first account name that are sent by the terminal are authentic and effective, where the identity authentication on the user succeeds, and allocate a registered account number for the user according to the account name.

When at least one pair among pairs of the second business account number and the first business account number, the second account name and the first account name, and the second transfer value and the first transfer value is different, it is indicated that fake information exists in the first business account number and the first account name sent by the terminal. Accordingly, identity authentication on the user fails, and no registered account number is allocated to the user. Alternatively, when the first recipient account number is not found, it is determined that the second recipient account number is different from the first recipient account number, identity authentication on the user fails, and no registered account number is allocated for the user.

In addition, the registration server further sends a resource return instruction to the transaction server, the resource return instruction includes a transaction serial number, and the transaction server determines the first recipient account number and the first business account number according to the transaction serial number, to return the resource, that is transferred out from the first business account number to the first recipient account number, to the first business account number.

The resource return instruction may further include a third transfer value. The third transfer value may be the same as the first transfer value or less than the first transfer value. No limitation is imposed in this embodiment.

The resource return instruction may further include at least one of a bank name of the first business account number, a bank address thereof, and a refund reason. No limitation is imposed in this embodiment.

When the transfer value is not specified by the registration server, that is, when operation 308 is performed after operation 304, operation 308 may include: allocating a registered account number for the user according to a first account name when the second business account number is the same as the first business account number, the second account name is the same as the first account name, and the second recipient account number is the same as the first recipient account number, and sending a resource return instruction to the transaction server, the resource return instruction being used for instructing the transaction server to return the resource, that is transferred out from the first business account number to the first recipient account number, to the first business account number.

Operation 309: The registration server sends a notification message used for indicating a registration success to the terminal.

The registration server may determine, according to the account number identifier, the terminal to send the notification message to the terminal.

The notification message may further include the registered account number allocated by the registration server for the user.

Operation 310: The terminal receives the notification message used for indicating a registration success sent by the registration server.

When the user transfer a resource from the first business account number to the first recipient account number transfer resource by using the terminal, the terminal further receives, by using the first business account number, the resource returned by the transaction server from the first recipient account number.

When the transaction server fails to return the resource to the first business account number, the transaction server sends status information of a return failure to the registration server. The registration server sends a resource return instruction to the transaction server again and does not stop sending the resource return instruction until the return succeeds or until a quantity of times of sending the resource return instruction exceeds a preset threshold. When the quantity of times of sending the resource return instruction exceeds the preset threshold, the registration server further generates a manual return request, to return the resource from the first recipient account number to the first business account number in a manual returning manner.

After an account number is successfully registered by using the account number registration method provided in this embodiment, authentication is not required in subsequently applying for another service by using the account number. Accordingly, convenience in subsequent service application may be improved. In addition, the account number successfully registered by using the account number registration method provided in this embodiment has high security, thereby providing guarantee for subsequent supervision and operation.

Operations 301, 304, 306, and 310 can be independently implemented as an embodiment on the terminal side, and operations 302, 303, 305, and 307-309 can be independently implemented as an embodiment on the registration server side.

In conclusion, the account number registration method provided by an exemplary embodiment includes: in an account number registration process, first receiving, by the registration server, a business account including the first account name and the first business account number of the user sent by the terminal; further, generating a recipient account including the first recipient account number and sending the recipient account to the terminal; and receiving indication information sent by the transaction server.

Because the indication information includes a second business account number from which the user transfers out a resource, a second account name corresponding to the second business account number, and a second recipient account number that receives that resource, when the second business account number is the same as the first business account number, the second account name is the same as the first account name, and the second recipient account number is the same as the first recipient account number, it is determined that authentication on identity of the user succeeds. After the authentication succeeds, a registered account number is automatically allocated for the user without manually performing authentication on legality of a business license. Therefore, efficiency of account number registration can be improved.

Because the first recipient account number includes a transaction account number used for receiving a resource transferred by the first business account number and a check code, and the check code in each first recipient account number uniquely identifies the first recipient account number, first recipient account numbers received by different terminals are different, and accuracy of an authentication procedure can be improved by performing authentication on the first recipient account number. Accordingly, security of an account number can be improved.

Because the first transfer value is randomly selected from the preset value range, performing authentication on the first business account number, the first account name, the first recipient account number, and the first transfer value simultaneously can further improve accuracy of the authentication procedure, thereby further improving security of an account number.

Exemplary apparatus embodiments are described below, and may be used to perform any one of exemplary method embodiments. For details not disclosed in the exemplary apparatus embodiments, details of the exemplary method embodiments may be referred to.

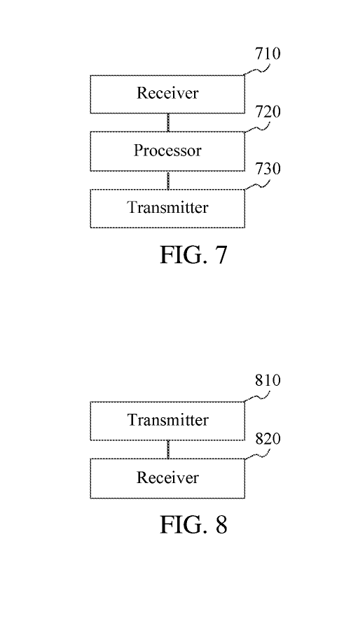

FIG. 7 is a structural block diagram of a registration server for account number registration according to still another embodiment. The registration server includes:

a receiver 710, configured to receive indication information sent by a transaction server, the indication information including a second business account number that transfers out a resource, a second account name corresponding to the second business account number of a terminal, and a second recipient account number that receives the resource;

a processor 720, configured to allocate a registered account number according to a first account name when the second business account number is the same as a first business account number, the second account name is the same as the first account name, and the second recipient account number is the same as a first recipient account number, the first business account number, the first account name, and the first recipient account number being pre-stored information; and a transmitter 730, configured to send a notification message used for indicating a registration success to the terminal.

Optionally, the receiver 710 is further configured to receive a business account sent by the terminal, the business account at least including the first account name and the first business account number.

The transmitter 730 is further configured to send a recipient account including the first recipient account number to the terminal, the first recipient account number being used for receiving, through the transaction server, the resource transferred by the first business account number.

The processor 720 is further configured to randomly select a first transfer value from a preset value range, the first transfer value being used for indicating a value of the resource transferred from the first business account number to the first recipient account number.

The transmitter 730 is further configured to send the first transfer value to the terminal.

Optionally, the processor 720 is further configured to trigger the operation of allocating a registered account according to a first account name when the indication information further includes a second transfer value used for indicating a value of the transferred out resource, and the second transfer value is the same as the first transfer value.

Optionally, the transmitter 730 is further configured to send a resource return instruction to the transaction server, the resource return instruction being used for instructing the transaction server to return the resource, that is transferred out from the first business account number to the first recipient account number, to the first business account number.

Optionally, the transmitter 703 is configured to send a notification message used for indicating a registration failure to the terminal if the indication information sent by the transaction server is not received within a preset time length.

Optionally, the transmitter 703 is configured to send the indication information including the second business account number when the first recipient account number includes a transaction account number receiving the resource and a check code, so that the transaction server determines that the second business account number includes the check code.

Optionally, the check code uniquely identifies the first recipient account number.

In conclusion, with regard to the registration server provided by an exemplary embodiment, in an account number registration process, the registration server first receives a business account including the first account name and the first business account number of the user sent by the terminal, further, generates a recipient account including the first recipient account number and sending the recipient account to the terminal, and receives indication information sent by the transaction server. Because the indication information includes a second business account number from which the user transfers out a resource, a second account name corresponding to the second business account number, and a second recipient account number that receives that resource, when the second business account number is the same as the first business account number, the second account name is the same as the first account name, and the second recipient account number is the same as the first recipient account number, it is determined that authentication on identity of the user succeeds. After the authentication succeeds, a registered account number is automatically allocated for the user without manually performing authentication on legality of a business license, so that efficiency of account number registration can be improved.

Because the first recipient account number includes a transaction account number used for receiving a resource transferred by the first business account number and a check code, and the check code in each first recipient account number uniquely identifies the first recipient account number, first recipient account numbers received by different terminals are different, and accuracy of an authentication procedure can be improved by performing authentication on the first recipient account number. Accordingly, security of an account number can be improved.

Because the first transfer value is randomly selected from the preset value range, perform authentication on the first business account number, the first account name, the first recipient account number, and the first transfer value simultaneously can further improve accuracy of the authentication procedure, thereby further improving security of an account number.

FIG. 8 is a structural block diagram of a terminal according to still another embodiment. The terminal includes the following:

a transmitter 810, configured to send a business account to a registration server, the business account including a first account name and a first business account number; and

a receiver 820, configured to receive a recipient account including the first recipient account number sent by the registration server, the first recipient account number being used for receiving, through the transaction server, the resource transferred by the first business account number; and

the receiver 820 being further configured to receive a notification message used for indicating a registration success sent by the registration server.

Optionally, the receiver 820 is further configured to receive a first transfer value randomly selected from a preset value range by and sent by the registration server, the first transfer value being used for indicating a value of the resource transferred from the first business account number to the first recipient account number.

Optionally, the receiver 820 is further configured to receive a notification message used for indicating a registration failure sent by the registration server.

Optionally, the first recipient account number includes a transaction account number receiving the resource transferred by the first business account number and a check code.

Optionally, the check code uniquely identifies the first recipient account number.

In conclusion, with regard to the terminal provided by an exemplary embodiment, in an account number registration process, the registration server first receives a business account including the first account name and the first business account number of the user sent by the terminal, further, generates a recipient account including the first recipient account number and sending the recipient account to the terminal, and receives indication information sent by the transaction server. Because the indication information includes a second business account number from which the user transfers out a resource, a second account name corresponding to the second business account number, and a second recipient account number that receives that resource, when the second business account number is the same as the first business account number, the second account name is the same as the first account name, and the second recipient account number is the same as the first recipient account number, it is determined that authentication on identity of the user succeeds. After the authentication succeeds, a registered account number is automatically allocated for the user without manually performing authentication on legality of a business license, so that efficiency of account number registration can be improved.

Because the first recipient account number includes a transaction account number used for receiving a resource transferred by the first business account number and a check code, and the check code in each first recipient account number uniquely identifies the first recipient account number, first recipient account numbers received by different terminals are different, and accuracy of an authentication procedure can be improved by performing authentication on the first recipient account number. Accordingly, security of an account number can be improved.

Because the first transfer value is randomly selected from the preset value range, perform authentication on the first business account number, the first account name, the first recipient account number, and the first transfer value simultaneously can further improve accuracy of the authentication procedure, thereby further improving security of an account number.

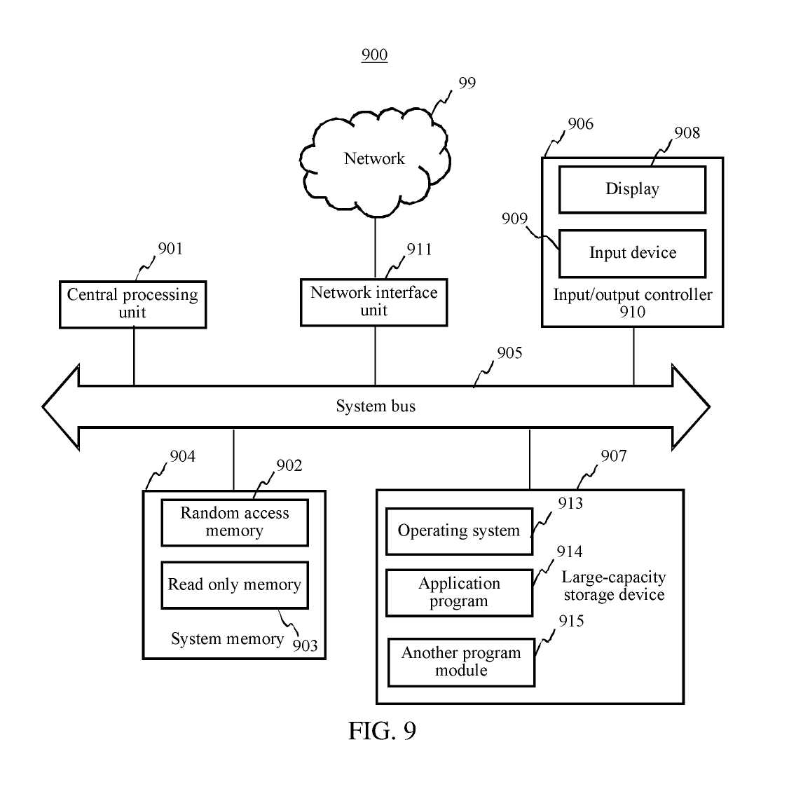

FIG. 9 is a schematic structural diagram of a registration server according to an embodiment from a perspective of a hardware entity.

The registration server 900 includes a central processing unit (CPU) 901, a system memory 904 including a random access memory (RAM) 902 and a read only memory (ROM) 903, and a system bus 905 connecting the system memory 904 and the CPU 901. The registration server 900 further includes a basic input/output system (I/O system) 906 assisting in transmitting information between devices in a computer, and a large-capacity storage device 907 configured to store an operating system 913, an application program 914 and another program module 915.

The basic I/O system 906 includes a display 908 configured to display information and an input device 909, such as a mouse or a keyboard, configured to input information for a user. The display 908 and the input device 907 are both connected to the CPU 901 by using an input and output controller 910 connected to the system bus 905. The basic I/O system 906 may further include the input and output controller 910 to be configured to receive and process inputs from multiple other devices such as a keyboard, a mouse, and an electronic stylus. Similarly, the input and output controller 910 further provides an output to a display screen, a printer or another type of output device.

The large-capacity storage device 907 is connected to the CPU 901 by using a large-capacity storage controller (not shown) connected to the system bus 905. The large-capacity storage device 909 and its associated computer readable medium provide non-volatile storage for the registration server 900. For example, the large-capacity storage device 909 may include the computer readable medium (not shown) such as a hard disk or a CD-ROM driver.

Without loss of generality, the computer readable medium may include a computer storage medium and a communications medium. The computer storage medium includes volatile and non-volatile media, and removable and non-removable media implemented by using any method or technology used for storing information such as a computer readable instruction, a data structure, a program module or other data. The computer storage medium includes a RAM, a ROM, an EPROM, an EEPROM, a flash memory or other solid storage technologies; a CD-ROM, a DVD or other optical storages; and a cassette, a magnetic tape, a disk storage or other magnetic storage devices. Certainly, persons skilled in art would understand that the computer storage medium is not limited to the foregoing several types. The system memory 904 and the large-capacity storage device 907 may be collectively referred to as a memory.

According to various embodiments, the registration server 900 may further be connected, by using a network such as the Internet, to a remote computer on the network and run. That is, the registration server 900 may be connected to a network 912 by using a network interface unit 911 connected to the system bus 905, or may also be to connected to another type of network or remote computer system (not shown) by using the network interface unit 911.

The memory further includes one or more programs. The one or more programs are stored in the memory and are used for implementing the account number registration method provided by the foregoing embodiments.

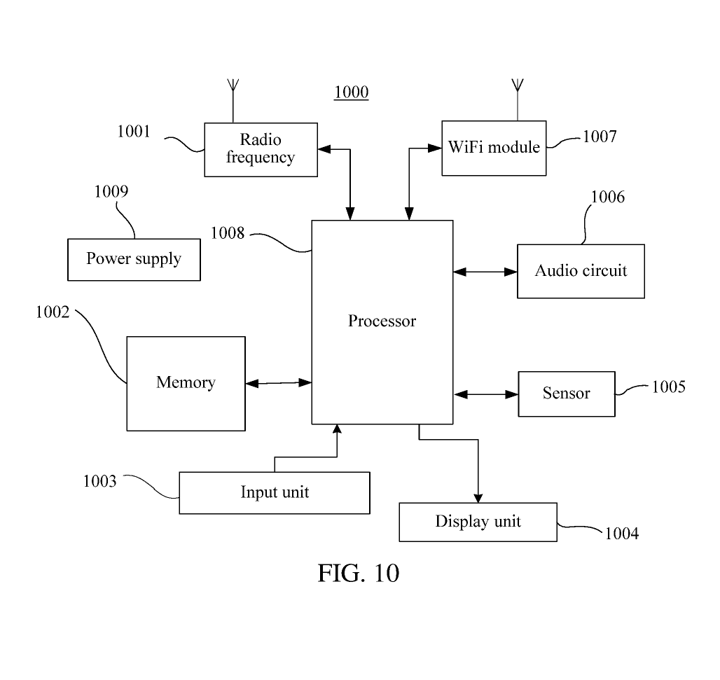

FIG. 10 is a schematic structural diagram of a terminal 1000 according to an embodiment from a perspective of a hardware entity.

The terminal may include components such as a radio frequency (RF) 1001, a memory 1002 including one or more computer readable storage media, an input unit 1003, a display unit 1004, a sensor 1005, an audio circuit 1006, a wireless fidelity (WiFi) module 1007, a processor 1008 including one or more processing cores, and a power supply 1009. A person skilled in the art may understand that the structure of the terminal shown in FIG. 10 does not constitute a limitation to the terminal, and the terminal may include more components or fewer components than those shown in the figure, or some components may be combined, or a different component deployment may be used.

The RF circuit 1001 may be configured to receive and send signals during information receiving and sending or during a call. Particularly, the RF circuit 110 receives downlink information from a base station, delivers the downlink information to one or more processors 1008 for processing, and sends related uplink data to the base station. Generally, the RF circuit 1001 includes but is not limited to an antenna, at least one amplifier, a tuner, one or more oscillators, a subscriber identity module (SIM) card, a transceiver, a coupler, a low noise amplifier (LNA), a duplexer, and the like. In addition, the RF circuit 1001 may also communicate with a network and another device by wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), an email, a short messaging service (SMS), and the like.

The memory 1002 may be configured to store a software program and module. The processor 1008 runs the software program and module stored in the memory 1002, to implement various functional applications and data processing. The memory 1002 may mainly include a program storage area and a data storage area. The program storage area may store an operating system, an application program required by at least one function (such as a sound playback function and an image display function), and the like. The data storage area may store data (such as audio data and an address book) created according to use of the terminal device, and the like. In addition, the memory 1002 may include a high speed random access memory, and may further include a non-volatile memory, such as at least one magnetic disk storage device, a flash memory, or other volatile solid-state storage devices. Correspondingly, the memory 1002 may further include a memory controller, to provide access of the processor 1008 and the input unit 1003 to the memory 1002.

The input unit 1003 may be configured to receive input digit or character information, and generate a keyboard, mouse, joystick, optical or track ball signal input related to the user setting and function control. In an exemplary embodiment, the input unit 1003 may include a touch-sensitive surface and another input device. The touch-sensitive surface, which may also be referred to as a touch screen or a touch panel, may collect a touch operation of a user on or near the touch-sensitive surface (such as an operation of a user on or near the touch-sensitive surface by using any suitable object or accessory such as a finger or a stylus), and drive a corresponding connection apparatus according to a preset program.

The touch-sensitive surface may largely include two parts: a touch detection apparatus and a touch controller. The touch detection apparatus detects a touch position of the user, detects a signal generated by the touch operation, and transfers the signal to the touch controller. The touch controller receives touch information from the touch detection apparatus, converts the touch information into touch point coordinates, and sends the touch point coordinates to the processor 10010. Moreover, the touch controller can receive and execute a command sent by the processor 1008. In addition, the touch-sensitive surface may be implemented in multiple types, such as a resistive type, a capacitive type, an infrared type, and a surface acoustic wave type. In addition to the touch-sensitive surface, the input unit 1003 may further include another input device. Specifically, the another input device may include but is not limited to one or more of a physical keyboard, a function key (for example, a volume control key or a power on/off key), a trackball, a mouse, or a joystick.

The display unit 1004 may be configured to display information input by the user or information provided for the user, and various graphical user interfaces of the terminal device. The graphical user interfaces may be composed of graphics, text, icons, videos, and any combination thereof. The display unit 1004 may include a display panel. Optionally, the display panel may be configured in a form of a liquid crystal display (LCD), an organic light-emitting diode (OLED), or the like. Further, the touch-sensitive surface may cover the display panel. After detecting a touch operation on or near the touch-sensitive surface, the touch-sensitive surface transfer the touch operation to the processor 1008 to determine a type of a touch event, and the processor 1008 provides corresponding visual output on the display panel according to the type of the touch event. Although in FIG. 10, the touch-sensitive surface and the display panel are used as two separate parts to implement input and output functions, in some embodiments, the touch-sensitive surface and the display panel may be integrated to implement the input and output functions.

The terminal may further include at least one sensor 1005 such as an optical sensor, a motion sensor, and other sensors. Specifically, the optical sensor may include an ambient light sensor and a proximity sensor. The ambient light sensor may adjust luminance of the display panel according to brightness of the ambient light. The proximity sensor may switch off the display panel and/or backlight when the terminal is moved to the ear. As one type of motion sensor, a gravity acceleration sensor may detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors such as a gyroscope, a barometer, a hygrometer, a thermometer, and an infrared sensor, which may be configured in the terminal, are not described in detail herein.

The audio circuit 1006, a speaker, and a microphone may provide audio interfaces between the user and the terminal. The audio circuit 1006 may convert received audio data into an electric signal and transmit the electric signal to the speaker. The speaker converts the electric signal into a sound signal for output. On the other hand, the microphone converts a collected sound signal into an electric signal. The audio circuit 1006 receives the electric signal and converts the electric signal into audio data, and outputs the audio data to the processor 1008 for processing. Next, the processor 1008 sends the audio data to, for example, another terminal by using the RF circuit 1001, or outputs the audio data to the memory 1002 for further processing. The audio circuit 1006 may further include an earplug jack, to provide communication between a peripheral earphone and the terminal.

WiFi is a short distance wireless transmission technology. The terminal may help, by using the WiFi module 1007, the user to receive and send e-mails, browse a web page, access streaming media, and so on, which provides wireless broadband Internet access for the user. Although FIG. 10 shows the WiFi circuit 1007, it may be understood that the wireless communications unit is not a necessary component of the terminal, and the wireless communications unit may be omitted without affecting the scope of the disclosure.

The processor 1008 is the control center of the terminal, and is connected to various parts of the terminal by using various interfaces and lines. By running or executing the software program and/or module stored in the memory 1002, and invoking data stored in the memory 1002, the processor performs various functions and data processing of the terminal, thereby performing overall monitoring on the terminal. The processor 1008 may include one or more processor cores. In an exemplary embodiment, the processor 1008 may integrate an application processor and a modem processor. The application processor mainly processes an operating system, a user interface, an application program, and the like. The modem processor mainly processes wireless communication. It may be understood that the foregoing modem processor may alternatively not be integrated into the processor 1008.

The terminal further includes the power supply 1009 (such as a battery) for supplying power to the components. In an exemplary embodiment, the power supply may be logically connected to the processor 1008 by using a power management system, thereby implementing functions such as charging, discharging, and power consumption management by using the power management system. The power supply 1009 may further include one or more of a direct current or alternating current power supply, a re-charging system, a power failure detection circuit, a power supply converter or inverter, a power supply state indicator, and any other components.

Although not shown in the figure, the terminal may further include a camera, a Bluetooth module, and the like, which are not described herein. Specifically, in this embodiment, the processor 1008 in the terminal runs one or more program instructions stored in the memory 1002, to implement the account number registration method provided in each of the foregoing method embodiments.

A person of ordinary skill in the art may understand that all or some of the operations of the methods in the foregoing embodiments may be implemented by a program instructing relevant hardware. The program may be stored in a computer readable storage medium. The storage medium may include: a read-only memory (ROM), a random access memory (RAM), a magnetic disk, an optical disc, or the like.

It should be noted that, when the server provided in the foregoing embodiment performs account number registration, only division of the foregoing functional modules is described by using an example. During actual application, the foregoing functions may be allocated to and completed by different functional modules according to requirements, that is, the internal structure of the server is divided into different functional modules, to complete all or some of the foregoing described functions. In addition, the server provided in the foregoing embodiments and embodiments of the account number registration method belong to one concept. For specific implementation procedures, refer to the method embodiments, and details are not described herein again.

The sequence numbers of the exemplary embodiments are merely for description purpose but do not indicate the preference of the embodiments.

A person of ordinary skill in the art may understand that all or some of the operations of the foregoing embodiments may be performed by using hardware, or may be performed by a program instructing relevant hardware. The program may be stored in a computer readable storage medium. The storage medium may be a read-only memory, a magnetic disk, an optical disc, or the like.

At least one of the components, elements, modules or units described herein may be embodied as various numbers of hardware, software and/or firmware structures that execute respective functions described above, according to an exemplary embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in some of block diagrams, communication between the components, elements or units may be performed through the bus. Functional aspects of the above exemplary embodiments may be implemented in algorithms that execute on one or more processors. Furthermore, the components, elements or units represented by a block or processing operations may employ any number of related art techniques for electronics configuration, signal processing and/or control, data processing and the like.

The foregoing descriptions are merely exemplary embodiments, but are not intended to limit the disclosure. Any modification, equivalent replacement, or improvement made within the spirit and principle of the disclosure shall fall within the protection scope of the disclosure.

What is claimed is:

1. An account number registration method, comprising:
receiving, by at least one processor of a registration server, indication information transmitted by a transaction server, the indication information comprising a second business account number of a terminal, a second account name corresponding to the second business account number, and a second recipient account number, a resource being transferred out from the second business account number to the second recipient account number;
allocating, by the at least one processor of the registration server, a registered account number according to a first account name in response to the second business account number being the same as a first business account number that is pre-stored, the second account name being the same as the first account name that is pre-stored, and the second recipient account number being the same as a first recipient account number that is pre-stored; and
transmitting, by the at least one processor of the registration server, a notification message indicating a registration success to the terminal.

2. The method according to claim 1, further comprising, prior to the receiving the indication information:
receiving a business account transmitted by the terminal, the business account at least comprising the first account name and the first business account number; and
transmitting a recipient account comprising the first recipient account number to the terminal, the first recipient account number being used for receiving the resource transferred by the first business account number.

3. The method according to claim 1, further comprising, prior to the receiving the indication information:
randomly selecting a first transfer value from a preset value range, and transmitting the first transfer value to the terminal, the first transfer value indicating a value of the resource transferred from the first business account number to the first recipient account number.

4. The method according to claim 3, further comprising:
triggering the allocating the registered account number according to the first account name, in response to the indication information further comprising a second transfer value, indicating a value of the transferred out resource, and the second transfer value being the same as the first transfer value.

5. The method according to claim 1, further comprising, after the receiving the indication information:
transmitting, to the transaction server, a resource return instruction based on which the resource, that is transferred out from the first business account number to the first recipient account number, is returned to the first business account number.

6. The method according to claim 1, further comprising:
transmitting a notification message indicating a registration failure to the terminal in response to the indication information transmitted by the transaction server not being received within a preset time length.

7. The method according to claim 2, wherein the indication information comprising the second business account number is transmitted in response to the first recipient account number comprising a transaction account number receiving the resource and a check code.

8. The method according to claim 7, wherein the check code uniquely identifies the first recipient account number.

9. A registration server, comprising:
a receiver, configured to receive indication information transmitted by a transaction server, the indication information comprising a second business account number of a terminal, a second account name corresponding to the second business account number, and a second recipient account number, a resource being transferred out from the second business account number to the second recipient account number;
a processor, configured to allocate a registered account number according to a first account name in response to the second business account number being the same as a first business account number that is pre-stored, the second account name being the same as the first account name that is pre-stored, and the second recipient account number being the same as a first recipient account number that is pre-stored; and
a transmitter, configured to transmit a notification message indicating a registration success to the terminal.

10. The registration server according to claim 9, wherein the receiver is further configured to receive a business account transmitted by the terminal, the business account at least comprising the first account name and the first business account number; and
the transmitter is further configured to transmit a recipient account comprising the first recipient account number to the terminal, the first recipient account number being used for receiving, through the transaction server, the resource transferred by the first business account number.

11. The registration server according to claim 9, wherein the processor is further configured to randomly select a first transfer value from a preset value range, the first transfer value indicating a value of the resource transferred from the first business account number to the first recipient account number; and
the transmitter is further configured to transmit the first transfer value to the terminal.

12. The registration server according to claim 11, wherein the processor is further configured to trigger the allocating the registered account number according to the first account name, in response to the indication information further comprising a second transfer value, indicating a value of the transferred out resource, and the second transfer value being the same as the first transfer value.

13. The registration server according to claim 9, wherein the transmitter is further configured to transmit, to the transaction server, a resource return instruction based on which the resource, that is transferred out from the first business account number to the first recipient account number, is returned to the first business account number.

14. The registration server according to claim 9, wherein the transmitter is further configured to transmit a notification message indicating a registration failure to the terminal in response to the indication information transmitted by the transaction server not being received within a preset time length.

15. The registration server according to claim 10, wherein the transmitter is further configured to transmit the indication information comprising the second business account number in response to the first recipient account number comprising a transaction account number receiving the resource and a check code.

16. The registration server according to claim 15, wherein the check code uniquely identifies the first recipient account number.

17. A non-transitory computer readable storage medium, comprising an instruction, the instruction, when being executed on a registration server, causing the registration server to perform:
receiving indication information transmitted by a transaction server, the indication information comprising a second business account number of a terminal, from which a resource is to be transferred out, a second account name corresponding to the second business account number, and a second recipient account number that receives the resource;
allocating a registered account number according to a first account name in response to the second business account number being the same as a first business account number that is pre-stored, the second account name being the same as the first account name that is pre-stored, and the second recipient account number being the same as a first recipient account number that is pre-stored; and
transmitting a notification message indicating a registration success to the terminal.

18. The non-transitory computer readable storage medium according to claim 17, wherein the instruction further causes the registration server to perform, prior to the receiving the indication information:
receiving a business account transmitted by the terminal, the business account at least comprising the first account name and the first business account number; and
transmitting a recipient account comprising the first recipient account number to the terminal, the first recipient account number being used for receiving the resource transferred by the first business account number.

19. The non-transitory computer readable storage medium according to claim 17, wherein the instruction further causes the registration server to perform, prior to the receiving the indication information:
randomly selecting a first transfer value from a preset value range, and transmitting the first transfer value to the terminal, the first transfer value indicating a value of the resource transferred from the first business account number to the first recipient account number.

20. The non-transitory computer readable storage medium according to claim 19, wherein the instruction further causes the registration server to perform, prior to the allocating the registered account number:
triggering allocating the registered account number according to the first account name, in response to the indication information further comprising a second transfer value, indicating a value of the transferred out resource, and the second transfer value being the same as the first transfer value.
